(19) United States
(12) Patent Application Publication
(10) Pub. No.: US 2012/0098249 A1
(43) Pub. Date: Apr. 26, 2012

(54) SECURITY ELEMENT, SECURITY SYSTEM AND PRODUCTION METHODS THEREFOR

(75) Inventors: Michael Rahm, Bad Toelz (DE); Wittich Kaule, Emmering (DE); Manfred Heim, Bad Toelz (DE); Andreas Rauch, Ohlstadt (DE); Josef Schinabeck, Gmund (DE); André Gregarek, Muenchen (DE); Angelika Hilgenrainer, Miesbach (DE)

(73) Assignee: GIESECKE & DEVRIENT GMBH, Muenchen (DE)

(21) Appl. No.: 13/322,431

(22) PCT Filed: May 12, 2010
(86) PCT No.: PCT/EP2010/056564

§ 371 Date: Jan. 2, 2012

(30) Foreign Application Priority Data
May 26, 2009 (DE) 102009022612.5

(51) Int. Cl. B42D 15/00; B23P 17/04

(52) U.S. Cl. 283/85; 29/592

(57) ABSTRACT

The invention relates to a security element for security papers, value documents or the like, with a carrier having an upper side and a lower side and comprising several reflective first micro-imaging elements flatly arranged in a first pattern, and second micro-imaging elements flatly arranged in a second pattern, a first microstructure object which contains several first microstructures which are arranged in a first microstructure pattern so adapted to the first pattern that the first microstructure object is imaged in magnified form in front of the upper side by means of the first micro-imaging elements, and a second microstructure object which contains several second microstructures which are arranged in a second microstructure pattern so adapted to the second pattern that the second microstructure object is imaged in magnified form in front of the underside by means of the second micro-imaging elements.

This invention relates to a security element, a security system and production methods therefor.

Objects to be protected are frequently equipped with a security element or security system which permits a check of the authenticity of the object and serves at the same time as protection from unauthorized reproduction.

Objects to be protected are for example security papers, identification and value documents (such as e.g. bank notes, chip cards, passports, identification cards, badge cards, shares, bonds, deeds, vouchers, checks, admission tickets, credit cards, health cards, . . . ) as well as product authentication elements, such as e.g. labels, seals, packages.

Thus, the security element can be used for example to cover an opening in an object to be protected, so that the security element is visible from both the front side and the back side of the object to be protected. For this purpose, the security element can have on both sides respectively several microlenses lying side by side as viewing elements which respectively focus onto a common microstructure plane, so that e.g. identical microstructure objects with different magnification and different motion behavior are perceptible from both sides. This disadvantageously leads to a very great total thickness of the security element compared to a security element that is observable only from one side and hence has microlenses only on one side.

On these premises, it is the object of the invention to provide a security element for security papers, value documents or the like which images a microstructure object on both sides of the security element and simultaneously has a smaller thickness than hitherto known security elements that image a microstructure object on both sides.

According to the invention, this object is achieved by a security element for security papers, value documents or the like, with a carrier having an upper side and a lower side and comprising several reflective first micro-imaging elements arranged flatly in a first pattern, and second micro-imaging elements arranged flatly in a second pattern, a first microstructure object which contains several first microstructures which are arranged in a first microstructure pattern so adapted to the first pattern that the first microstructure object is imaged in magnified form in front of the upper side by means of the first micro-imaging elements, and a second microstructure object which contains several second microstructures which are arranged in a second microstructure pattern so adapted to the second pattern that the second microstructure object is imaged in magnified form in front of the lower side by means of the second micro-imaging elements.

Through the use of the reflective first micro-imaging elements it is possible to reduce the total thickness of the security element, because the focal length of reflective micro-imaging elements is considerably smaller than with comparable microlenses.

The first and second micro-imaging elements can lie on the same side relative to the microstructure objects. In particular, the first and second micro-imaging elements can lie in the same plane. This leads to a reduction of thickness of the security element and simplifies production. When an embossing step is necessary for producing the micro-imaging elements, it can be carried out simultaneously for the first and second micro-imaging elements.

The microstructures can also lie in the same plane, which again causes a reduction of thickness of the security element.

The first and second micro-imaging elements are preferably configured as focusing imaging elements. The micro-imaging elements can be so configured and arranged that their focal points lie in the same plane, which facilitates the production of the two microstructure objects, because they are to be produced only in one plane.

In particular, the first micro-imaging elements can be configured as micro-concave mirrors. The same holds for the second micro-imaging elements, which can alternatively also be configured as microlenses.

The curved mirror surface of at least one of the micro-concave mirrors and the at least one curved boundary surface of at least one of the microlenses is preferably curved spherically. However, aspherical curvatures are also possible.

In the security element of the invention, at least one of the first micro-imaging elements can also act as a second micro-imaging element. This is possible for example through a partly transparent mirror coating. A similar effect is achievable by the first micro-imaging elements being bloomed respectively in certain areas. They can be bloomed e.g. in gridded fashion on a scale below the resolving power of the eye. In the mirror-coated areas the imaging elements act as reflective first imaging elements, while in the areas that are transparent through blooming the imaging elements act as second imaging elements.

The areas that are transparent through blooming can thus be configured for example as pinhole diaphragms (when the reflective first imaging elements are configured as cylindrical concave mirrors, for example as slit diaphragms). Said diaphragms preferably act as non-focusing micro-imaging elements.

In the case of a moire magnification arrangement, which will be described hereinafter in connection with the embodiment examples, the grids of the diaphragms and of the reflective first imaging elements need not match. In the configuration as a modulo magnification arrangement, which will likewise be described hereinafter in connection with the embodiment examples, the grid cells are already defined by the grid of the reflective first imaging elements or the grid of the diaphragms, so that at least the period of the grid of the diaphragms or of the reflective first imaging elements is then likewise defined.

In the described embodiments in connection with the areas that are transparent through blooming, both microstructure objects are preferably realized by the same structure.

Further, it is possible to bloom one or several of the first micro-imaging elements partly in such a way that the bloomed area of the respective micro-imaging element acts as a refractive element and the mirror-coated areas respectively as concave mirrors.

In the security element, the first and/or second micro-imaging elements can be embedded in the carrier. This provides a very compact security element.

The microstructure objects may involve different structures or the same structure. The microstructure objects and the micro-imaging elements can be so designed that the same or different motifs with the same or different motion behavior or magnification behavior result when regarded from the upper side and lower side.

In particular, the micro-imaging elements can be so designed that the same motif seems to lie behind the carrier when viewed from one side of the carrier and seems to lie in front of the carrier when viewed from the other side, thereby impressively strengthening the impression of the three-dimensionality of the motif.

For producing the micro-imaging elements and also the microstructures there can be employed known microstructuring methods, such as e.g. embossing methods. Thus, for example using methods known from semiconductor fabrication (photolithography, electron beam lithography, laser lithography, . . . ) suitable structures in resist materials can be exposed, possibly refined, molded, and employed for fabricating embossing tools. Known methods for embossing into thermoplastic foils or into foils coated with radiation-curing lacquers are particularly suitable for producing large surfaces.

The carrier preferably has several layers which are successively applied and optionally structured, and/or is assembled from several parts.

The security element can be configured in particular as a security thread, tear thread, security band, security strip, patch or as a label for application to a security paper, value document or the like. In particular, the security element can span transparent areas or recesses, so that the first microstructure object is visible from one side of the security element and the second microstructure object from the other side thereof.

The term security paper is understood here to be in particular the not yet circulable precursor to a value document, which can have besides the security element of the invention for example also further authenticity features (such as e.g. luminescent substances provided within the volume). Value documents are understood here to be, on the one hand, documents produced from security papers. On the other hand, value documents can also be other documents and objects that can be provided with the security feature of the invention in order for the value documents to have uncopiable authenticity features, thereby making it possible to check authenticity and at the same time preventing unwanted copies.

The dimensions of the micro-imaging elements and of the microstructures are preferably so chosen that they lie below the resolving power of the human eye. In particular, the dimensions can lie in a range of 1 μm to 50 μm or of 3 μm to 50 μm.

The first and second patterns and the first and second microstructure patterns can be configured as a hexagonal grid or also as a polygonal grid, such as e.g. a rectangular or parallelogrammatic grid.

There is further provided a security system for security papers, value documents or the like, with a first carrier having an upper side and a lower side and comprising several reflective first micro-imaging elements arranged flatly in a first pattern, said elements having a first object plane area associated therewith, and second micro-imaging elements arranged flatly in a second pattern, said elements having a second object plane area associated therewith, a first microstructure object which contains several first microstructures arranged in a first microstructure pattern, a second microstructure object which contains several second microstructures arranged in a second microstructure pattern, and a second carrier, whereby one of the two structure objects is connected to the second carrier and the other of the two structure objects either to the first or second carrier, the first microstructure pattern is so adapted to the first pattern that the first microstructure object, when it lies in the first object plane area, is imaged in magnified form in front of the upper side of the first carrier by means of the first micro-imaging elements, and the second microstructure pattern is so adapted to the second pattern that the second microstructure object, when it lies in the second object plane area, is imaged in magnified form in front of the lower side of the first carrier by means of the second micro-imaging elements.

Due to the reflective first micro-imaging elements, the thickness of the first carrier can be kept very small.

The first and second micro-imaging elements and the first and second microstructure objects can be developed in the same way as in the security element of the invention.

In the security system, the first carrier can be configured in the same way as the security element for example as a security thread, tear thread, security band, security strip, patch or label for application to a security paper, value document or the like. The same holds for the second carriers [sic]. In particular, the first and second carriers can be applied to the same security paper, value document or the like. Thus, they can be applied for example to a bank note spaced apart from each other, so that through a bending, creasing or folding of the bank note there is effected the desired arrangement of the first or second microstructure pattern in the first or second object plane area in order to image the first or second microstructure object in magnified form.

Furthermore, there is provided a production method for a security element for security papers, value documents or the like by which a carrier having an upper side and a lower side and comprising several reflective first micro-imaging elements arranged flatly in a first pattern and second micro-imaging elements arranged flatly in a second pattern is produced, a first microstructure having several first microstructures is so produced that they are arranged in a first microstructure pattern so adapted to the first pattern that the first microstructure object is imaged in magnified form in front of the upper side by means of the first micro-imaging elements, and a second microstructure object having several second microstructures is so produced that they are arranged in a second microstructure pattern so adapted to the second pattern that the second microstructure object is imaged in magnified form in front of the lower side by means of the second micro-imaging elements.

The production method of the invention can be so developed that the described preferred configurations and embodiments of the security element are produced.

Furthermore, there is provided a production method of a security system for security papers, value documents or the like by which a first carrier having an upper side and a lower side and comprising several reflective first micro-imaging elements arranged flatly in a first pattern, said elements having a first object plane area associated therewith, and second micro-imaging elements arranged flatly in a second pattern, said elements having a second object plane area associated therewith, is produced, a first microstructure object which contains several first microstructures arranged in a first microstructure pattern is produced, a second microstructure object which contains several second microstructures arranged in a second microstructure pattern is produced, one of the two microstructure objects is connected to a second carrier and the other of the two microstructure objects either to the first or second carrier, whereby the first microstructure pattern is so adapted to the first pattern that the first microstructure object, when it lies in the first object plane area, is imaged in magnified form in front of the upper side of the first carrier by means of the first micro-imaging elements, and the second microstructure pattern is so adapted to the second pattern that the second microstructure object, when it lies in the second object plane area, is imaged in magnified form in front of the lower side of the first carrier by means of the second micro-imaging elements.

This production method can be so developed that the described preferred configurations and embodiments of the security system are produced.

Further, there is provided a value document and a security paper having a security element of the invention (or one of its developments) or having at least one of the carriers of the security system of the invention.

It is evident that the features mentioned hereinabove and those to be explained hereinafter can be used not only in the stated combinations but also in other combinations or in isolation without going beyond the scope of the present invention.

Hereinafter the invention will be explained more closely by way of example with reference to the attached drawings, which also disclose features essential to the invention. There are shown:

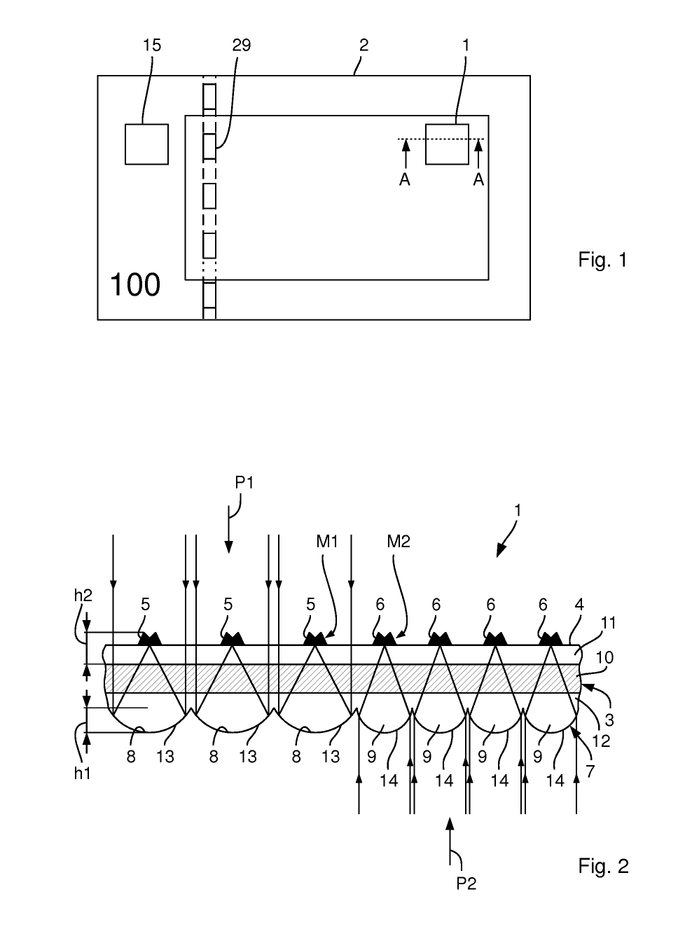

FIG. 1 a plan view of a bank note having a security element 1 of the invention;

FIG. 2 an enlarged portion of a part of the section along the line A-A in FIG. 1;

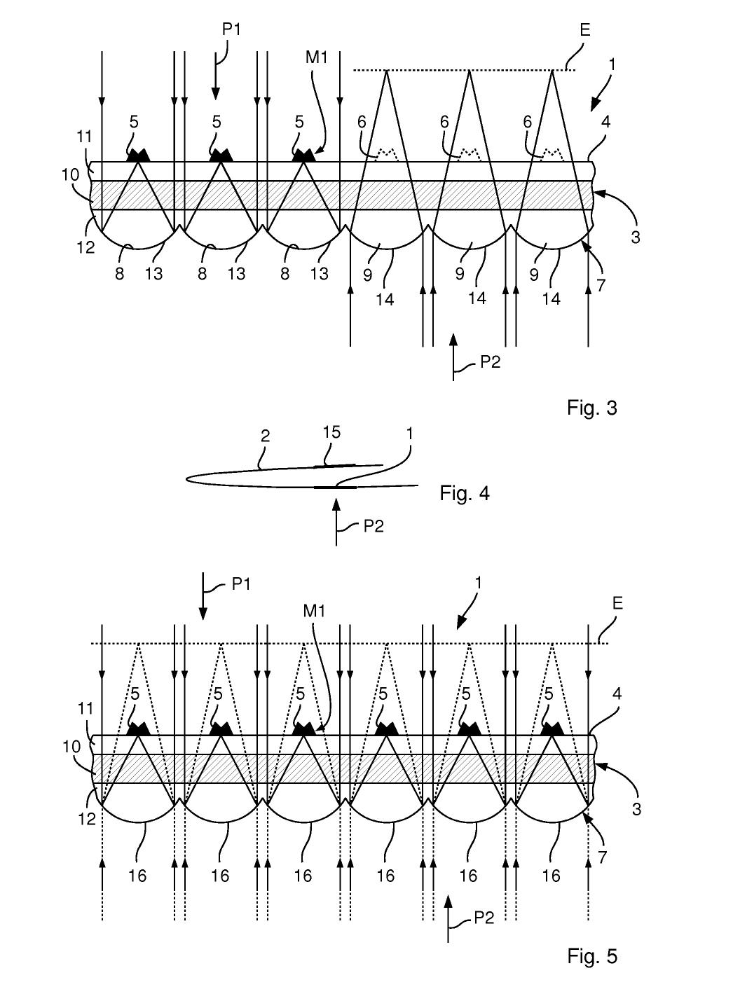

FIG. 3 a sectional view according to FIG. 2 of a further embodiment of the security element of the invention;

FIG. 4 a side view of the bank note of FIG. 1 for explaining the self-verification;

FIG. 5 a sectional view according to FIG. 2 of a further embodiment of the security element of the invention;

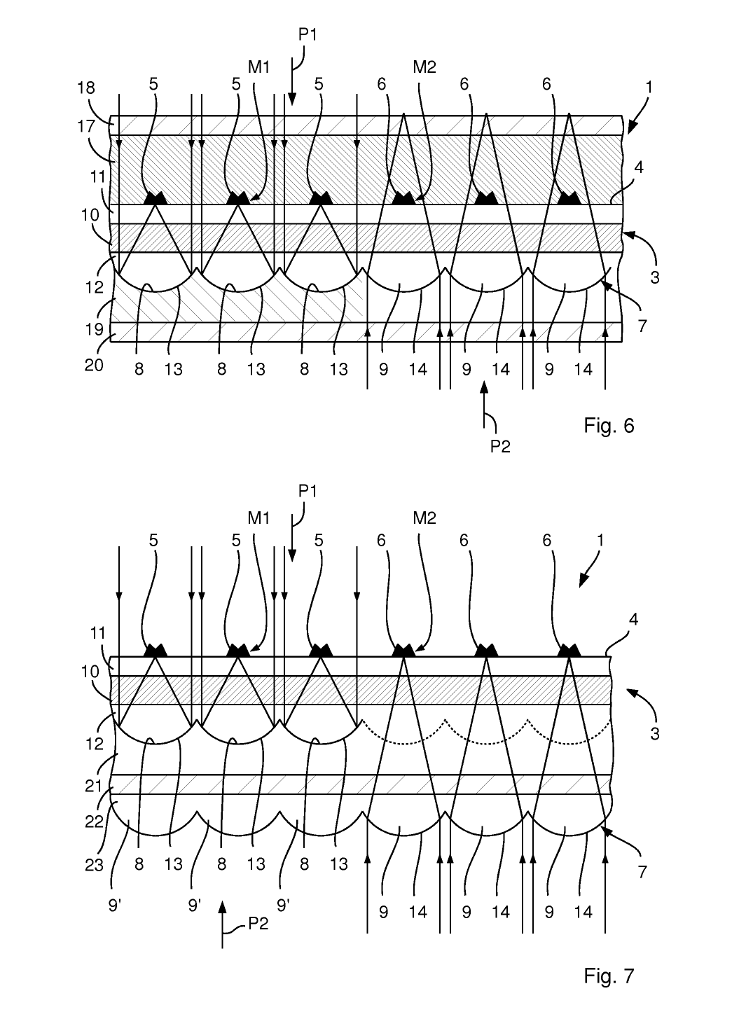

FIG. 6 a sectional view according to FIG. 2 of a further embodiment of the security element of the invention;

FIG. 7 a sectional view according to FIG. 2 of a further embodiment of the security element of the invention;

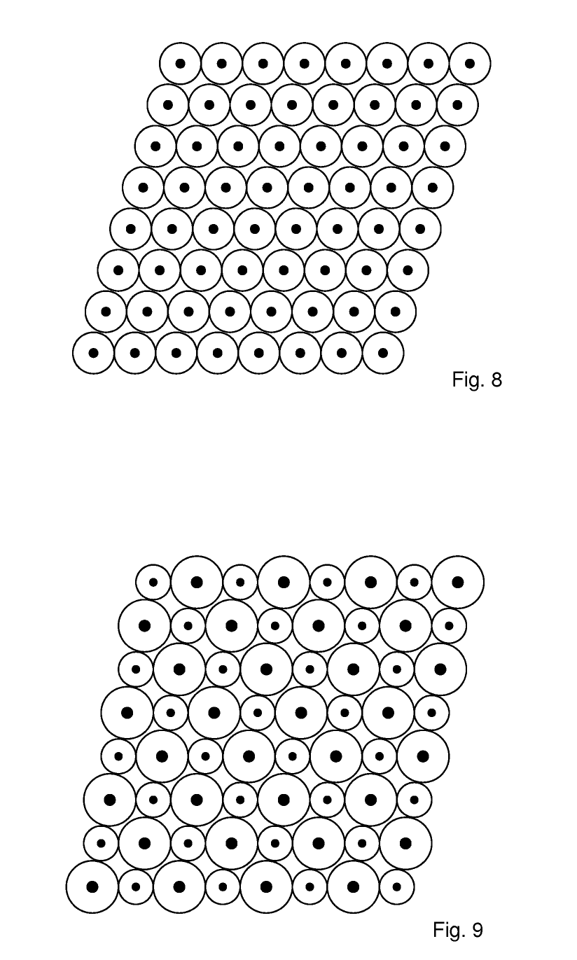

FIG. 8 an enlarged plan view of the security element of FIG. 7 from viewing direction P2 onto the left area with the microlenses 9′;

FIG. 9 an enlarged plan view according to FIG. 8 of a modified embodiment of the security element of FIG. 7;

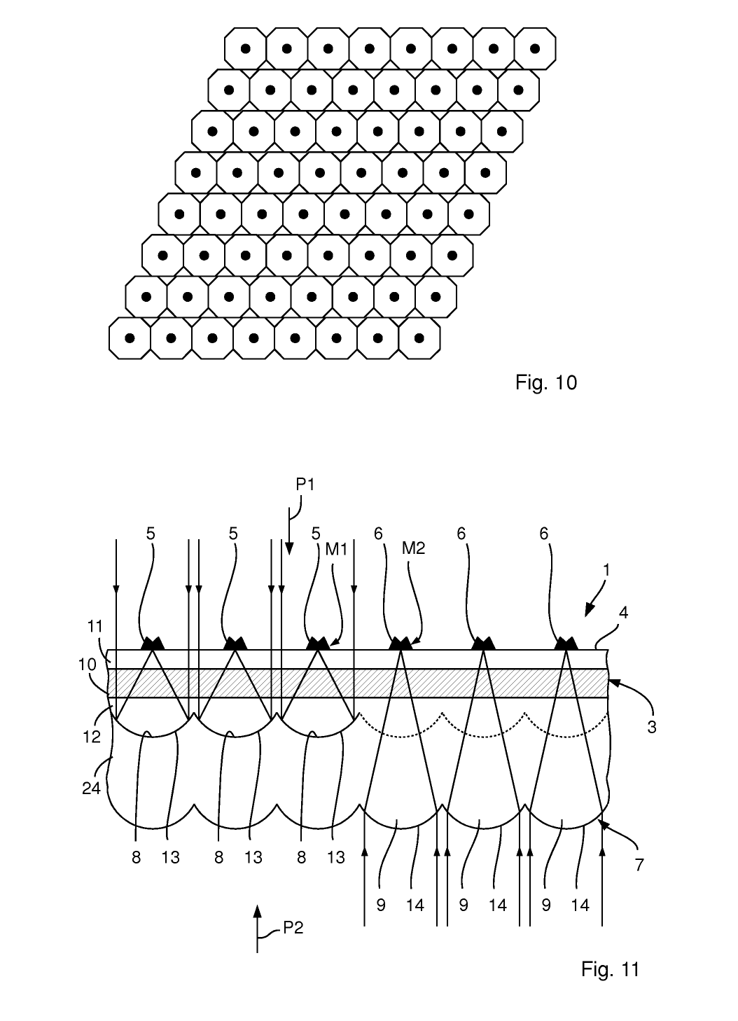

FIG. 10 an enlarged plan view according to FIG. 8 of a further modified embodiment of the security element of FIG. 7;

FIG. 11 a sectional view according to FIG. 2 of a further embodiment of the security element of the invention;

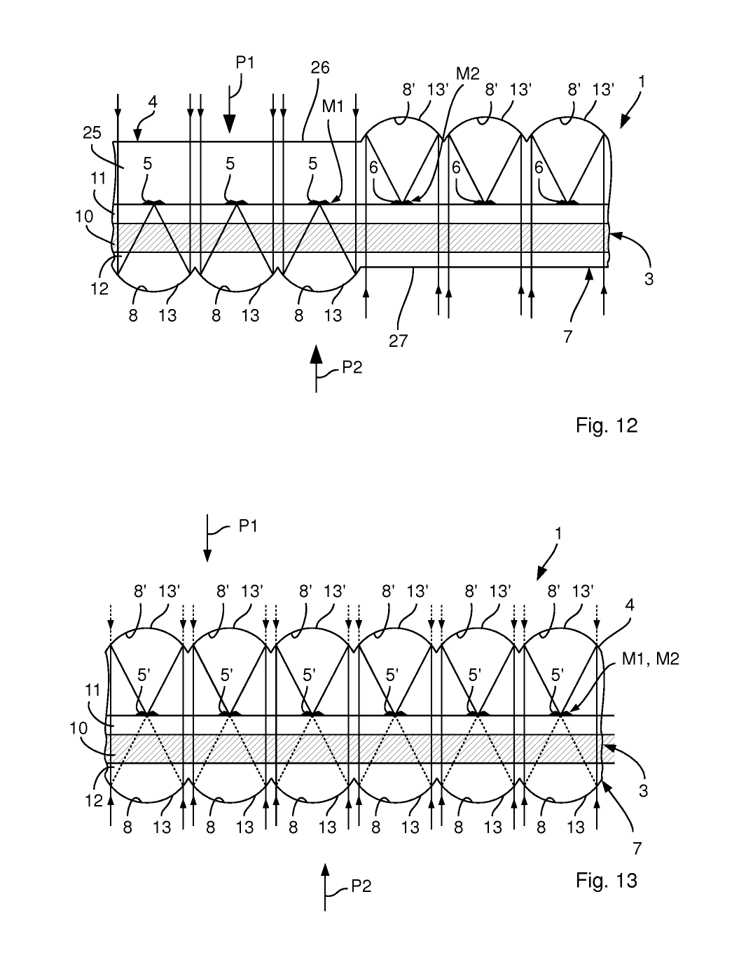

FIG. 12 a sectional view according to FIG. 2 of a further embodiment of the security element of the invention;

FIG. 13 a sectional view of a double-sided embodiment of the security element of the invention; and

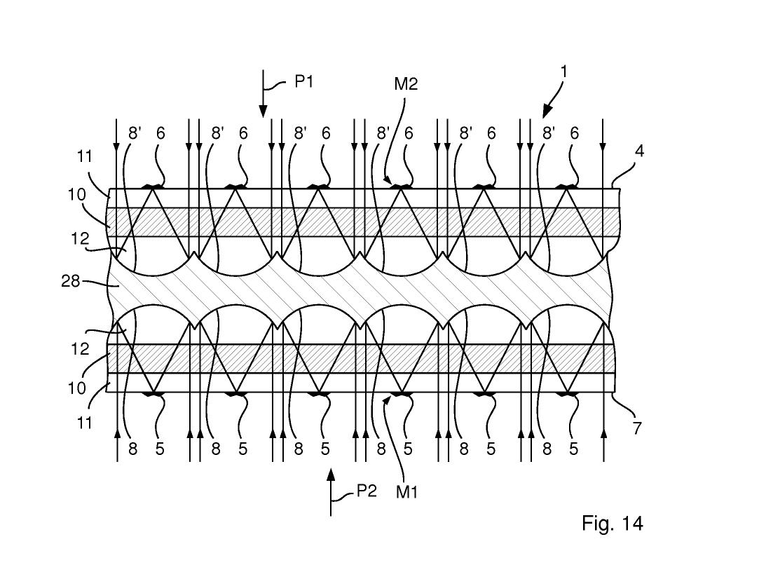

FIG. 14 a sectional view of a further double-sided embodiment of the security element of the invention.

In the embodiment shown in FIG. 1, the security element 1 of the invention is so integrated into a bank note 2 that the security element 1 is visible both from the front side of the bank note 2 shown in FIG. 1 and from the back side of the bank note 2.

As indicated by the sectional representation in FIG. 2, which shows in enlarged form a part of the security element 1 along the sectional line A-A of FIG. 1, the security element 1 comprises a carrier 3 which has embossed first and second microstructures 5, 6 on its upper side 4 and several micro-concave mirrors 8 and several microlenses 9 in certain portions on its lower side 7.

The sectional view of FIG. 2 and all further sectional views of further embodiments of the security element 1 of the invention are, for the sake of better representability, not represented true to scale. Further, hatching is sometimes omitted in order for the structure of the corresponding security element 1 to be able to be depicted more clearly.

The micro-concave mirrors 8 are arranged in a plane perpendicular to the drawing plane of FIG. 2 in a grid with fixed geometry (here for example a hexagonal grid) and thus flatly in a first pattern.

The first microstructures 5 which form a first microstructure object or image M1 are likewise arranged in a plane perpendicular to the drawing plane of FIG. 2 in a grid with fixed geometry (here for example a hexagonal grid) and thus flatly in a first microstructure pattern, whereby the first microstructure pattern is so adapted to the first pattern and the two patterns so oriented relative to each other that upon viewing of the security element 1 from the upper side (direction of the arrow P1) the first microstructures 5 form together with the micro-concave mirrors 8 a modulo magnification arrangement. The basic principle of such a modulo magnification arrangement is described for example in WO 2009/000528 A1, whose total content is also included here, whereby the first microstructure object M1 of the present invention corresponds to the motif image according to the teaching of WO 2009/000528 A1.

Thus, at a viewing direction onto the upper side (direction of arrow P1) the first microstructure object M1 is perceptible to a viewer in magnified form as a first security feature (as the “desired image” according to WO 2009/000528 A1). It may involve e.g. the letter P.

It is of course also possible to mutually coordinate the first microstructure pattern of the first microstructures 5 and the first pattern of the micro-concave mirrors 8 such that a moire magnification arrangement is present. The basic principle of a moire magnification arrangement is described for example in WO 2006/087138 A1, whose total content is also included here.

Further, the microlenses 9 are arranged in a plane perpendicular to the drawing plane of FIG. 2 in a grid with fixed geometry (e.g. a hexagonal grid or parallelogram grid) and thus flatly in a second pattern. The second microstructures 6 which form a second microstructure object or image M2 are likewise arranged in a plane perpendicular to the drawing plane of FIG. 2 in a grid with fixed geometry (here e.g. a hexagonal grid or parallelogram grid) and thus flatly in a second microstructure pattern. The second microstructure pattern and the second pattern are so adapted to each other and oriented relative to each other that upon viewing of the security element 1 from the lower side 7 (i.e. in the direction of the arrow P2) there is again present a modulo or moire magnification arrangement. A viewer can thus perceive the second microstructure object M2 as a second security feature (e.g. as the letter L), whereby the security element 1 is preferably so configured that the two security features are different. It is of course also possible that the two security features are the same.

In the structure shown in FIG. 2, the carrier 3 comprises a PET foil 10 to which there is applied a first layer 11 of radiation-curing lacquer (for example UV lacquer) which has the first and second microstructures 5, 6. The microstructures 5, 6 can be produced in the known way, for example by embossing into the UV lacquer 11 and subsequently printing on and scraping off ink. As further coloring methods there can be used certain ink transfer methods or micro-gravure printing technologies, which are described for example in PCT/EP2008/010739 or WO 2008/000350 and whose disclosure is included in the present application in this respect.

On the lower side of the PET foil 10 there is formed a second layer 12 of radiation-curing lacquer (for example UV lacquer) in which the negative form of the micro-concave mirrors 8 and the form of the microlenses 9 is embossed. For producing the micro-concave mirrors 8 the side of the second layer 12 facing away from the PET foil 10 is coated with a mirror coating 13 (e.g. a metallization). The micro-concave mirrors 8 are thus configured as back-surface mirrors.

The inner side of the mirror coating 13 of each micro-concave mirror 8, or the embossed form for the micro-concave mirrors 8, has here the form of a spherical cap with a radius of curvature of 38 μm and a height h1 of approximately 3 μm. The maximum thickness of the second layer 12 (from the vertex of a micro-concave mirror 8 to the PET foil 10) amounts to 5 μm here, the PET foil 10 has a thickness of 12 μm and the height h2 of the layer 11 including the microstructures 5, 6 amounts to 2 μm.

Because the radius of curvature of the micro-concave mirrors 8 amounts to 38 μm, the micro-concave mirrors 8 have a focal length of 19 μm. Due to the described structure, the first microstructures 5 are spaced from the micro-concave mirrors 8 by 19 μm and thus lie in the same plane as the focal points of the micro-concave mirrors 8, so that there is effected the desired magnifying imaging of the first microstructures 5 for producing the first security feature. The plane area in which the focal points of the micro-concave mirrors 8 lie can also be designated the first object plane area, and is here the portion of the upper side 4 where the first microstructures 5 are formed.

The convex side 14 of the microlenses 9 likewise has the form of a spherical cap, whereby the radius of curvature amounts to approximately 6.3 μm here, however, so that the focal length of the microlenses 9 is likewise 19 μm, thereby making the desired imaging of the second security feature possible. The portion of the upper side 4 where the focal points of the microlenses 9 lie can also be designated the second object plane area. The height of the spherical caps of the convex sides again amounts to 3 μm. The height of the micro-concave mirrors 8 and of the microlenses 9 is thus the same here. The heights can of course also be different.

It should be pointed out that the stated size values are to be understood only by way of example here and hereinafter. Other values can result in dependence on e.g. the employed materials, pattern sizes. This also holds for all the other embodiments described here.

As indicated in FIG. 2 by the shown ray trajectories, the micro-concave mirrors 8 cause a magnifying imaging of the first microstructures 5 through the upper side 4 of the carrier 3 and thus in front of the upper side 4, so that a viewer looking at the security element 1 in the direction of the arrow P1 perceives the first microstructure object M1 through the moire or modulo magnification as a first security feature.

By means of the microlenses 9 there is effected a magnifying imaging of the second microstructures 6 through the lower side 7 of the carrier 3 and thus in front of the lower side 7, as indicated by the shown ray trajectories, so that a viewer looking at the security element 1 in the direction of the arrow P2 can perceive the second microstructure object M2 through the moire or modulo magnification as a second security feature.

The security element 1 of the invention thus offers different optical security features or information to a viewer in dependence on whether the viewer looks at the upper side 4 or the lower side 7 of the carrier 3.

Because the first and second microstructures 5, 6 lie in a first plane and the micro-concave mirrors 8 and microlenses 9 lie in a second plane, there can be provided a very compact security element 1 with a small total thickness.

When the microlenses 9 and the micro-concave mirrors 8 lie in the same plane, the phase between the microlenses 9 and the micro-concave mirrors 8 can be adjusted in targeted fashion. This can be useful when the information visible from the viewing direction P1 is to be in a defined relation to the information recognizable from the viewing direction P2.

In FIG. 3 there is shown a sectional view of a second embodiment of the security element 1 of the invention, whereby in this and all subsequent embodiments the same elements are designated with the same reference signs and reference is made for their description to the above remarks.

The security element 1 according to FIG. 3 differs from the security element 1 in FIG. 2 by the radius of curvature of the convex side 14 of the microlenses 9. The radius of curvature here is equally large as in the micro-concave mirrors 8 and thus amounts to 38 μm, which leads to a focal length of approximately 115 μm. As evident in the schematic representation in FIG. 3, the focal points of the microlenses 9 and thus the second object plane area thus no longer lie within the security element 1, but rather outside in a plane E depicted by the dashed line.

The microlenses 9 can in this case be employed for example for self-verification, by positioning a third microstructure object or image 15, which the bank note contains at a place spaced from the security element 1 (FIG. 1), in front of the upper side 4 of the carrier 3 of the security element 1 in the plane E by e.g. bending, creasing or folding of the bank note 1 (FIG. 4), so that the microstructure object 15 is then imaged in magnified form through the lower side 7 by means of the microlenses 9.

The third microstructure object 15 can have e.g. in the same way as the second microstructures 6 third microstructures arranged in grid form (not shown), so that the third microstructure object 15 is imaged in magnified form by means of the microlenses 9 as a third security feature (e.g. as the number 100, which corresponds to the value of the bank note). Hence, a viewer can perceive the third security feature when looking at the lower side of the bank note 2 (viewing direction according to arrow P2) which is bent or folded according to FIG. 4. The distance of the third microstructure object 15 from the upper side 4 is, in so doing, adapted to the focal length of the microlenses 9 automatically by a viewer according to experience, so that he will position the third microstructure object 15 in the plane E.

It is of course also possible to arrange the third microstructure image 15 of a further bank note (not shown) in front of the upper side 4 of the security element 1 in the plane E in order to cause a magnified imaging by means of the microlenses 9 through the lower side 7, so that a mutual verification of the bank notes 1 can be carried out. The third microstructure image 15 of the further bank note forms in this case together with the security element 1 a security system.

Because the second microstructures 6 cannot be represented sharply by the microlenses 9 (they lie too far away from the focal points of the microlenses 9), the second microstructures 6 can of course also be omitted in the embodiment of FIG. 3. Hence, the second microstructures are depicted only by dashed lines.

Alternatively, it is also possible in the embodiment examples hitherto set forth to coat the convex sides 14 in partly transparent fashion, so that upon a viewing direction in the direction of the arrow P1 the partly transparently coated convex sides 14 therefore act as micro-concave mirrors, so that the second microstructures 6, if they are formed, are imaged in magnified form in front of the front side 4.

In the sectional representation of FIG. 5 there is shown a further embodiment of the security element 1 which has the same geometrical dimensions as the embodiment of FIG. 3. However, in the embodiment of FIG. 5 the total lower side 7 is mirror-coated semi-transparently, so that there are formed micro-imaging elements 16 that act respectively both as micro-concave mirrors and as microlenses. The multiplicity of micro-imaging elements 16 thus act both reflectively (for a viewing from the upper side 4 of the carrier 3) and refractively (also for a viewing from the lower side 7 of the carrier 3). Thus, the first microstructures 5 can extend over a greater area of the upper side 4. Because the first microstructures 5 are sufficiently spaced from the focal points of the refractively acting micro-imaging elements 16, the first microstructures 5 do not interfere with the refractive imaging.

The reflective effect is indicated by the ray trajectories shown by continuous lines, and the refractive effect by the dashed ray trajectories. Further, there is again shown the plane E in which the focal points of the micro-imaging elements lie upon a refractive effect.

Of course, not all micro-imaging elements 16 need be mirror-coated semi-transparently. It is quite possible not to mirror-coat some of the micro-imaging elements 16 at all, so that they act as strict microlenses 9, and to mirror-coat some of the micro-imaging elements 16 such that they act only as micro-concave mirrors 8. When the surface areas where the micro-imaging elements act exclusively either reflectively or refractively lie below the resolving power of the eye, a similar effect can be achieved as in the case of a full-surface semi-transparent mirror coating.

In FIG. 6 there is shown an embodiment of the security element 1 of the invention wherein the security element 1 is inserted into a foil composite bank note 2. The upper side 4 of the carrier 3 here is connected to the back-side foil 18 of the bank note 2 via a first adhesive layer 17 of laminating adhesive. The lower side 7 of the carrier 3 is connected to the front-side foil 20 of the bank note 2 via a second adhesive layer 19 of laminating adhesive, whereby the laminating adhesive was applied only in the area of the micro-concave mirrors 8 and not in the area of the microlenses 9, however, so as not to adversely alter the optical imaging properties of the microlenses 9.

Of course, it is possible to provide the total lower side 7 and thus also in the area of the microlenses 9 with laminating adhesive to bond the security element 1 to the front-side foil 20. For this purpose, it is merely necessary to employ a laminating adhesive with a suitable refractive-index difference relative to the lens material, so that the microlenses still have a suitable focal length in the inserted state of the security element in the bank note 2.

In the example shown in FIG. 6, the focal length of the microlenses 9 is so defined that it is just on the free side of the back-side foil 18. In this case the self-verification or mutual verification is very easy to carry out, because the third microstructure object 15 need only be placed directly on the free side of the back-side foil 18.

In the hitherto described embodiments, the micro-concave mirrors 8 and the microlenses 9 were respectively in the same plane and it was therefore possible to carry out only one embossing step for producing the micro-concave mirrors 8 and the microlenses 9. However, it is also possible to form the micro-concave mirrors 8 and the microlenses 9 in different planes, as shown in the sectional representation of FIG. 7.

The structure of the layers 10 to 12 is the same as in the embodiment of FIG. 3, whereby in FIG. 7 the mirror-coated sides of the micro-concave mirror 8 are shown by continuous lines and the embossed portions of the layer 12 which are not mirror-coated (and are the convex lens sides 14 in the embodiment of FIG. 3) are shown by dashed lines.

To the layer 12 there is bonded by means of a laminating adhesive 21 a second PET foil 22 with a UV lacquer layer 23 formed thereon, convex sides 14 of the microlenses 9 being embossed in the UV lacquer layer 23. The convex sides 14 have the form of a spherical cap, with a radius of curvature of 18 μm. The distance from the vertex of the respective spherical cap to the second PET foil 22 amounts to 10 μm. The thickness of the second PET foil 22 amounts to 23 μm and the thickness of the laminating adhesive layer 21 from the second PET foil 22 to the vertex of the micro-concave mirrors 8 amounts to 2 μm.

Due to the radius of curvature of the convex sides 14 of the microlenses 9 of 18 μm, the microlenses 9 have a focal length of 54 μm, which corresponds here to the distance between the vertex of the convex sides 14 and the second microstructures 6.

The security element 1 shown in FIG. 7 has a peculiarity: in the area of the reflective imaging elements 8 there are also refractive imaging elements, here microlenses 9′. Because in the case of an opaque coating of the micro-concave mirrors 8 the microlenses 9′ are separated optically from the microstructures 5, the microlenses 9′ in this area of the security element 1 cannot image the first microstructures 5 and can therefore also be omitted. Alternatively, there can be used in these areas other embossed structures, such as e.g. hologram structures or also matt structures.

The embodiment shown in FIG. 7 can be so modified that the micro-concave mirrors 8 are mirror-coated partly transmissively. Further, the portions shown by dashed lines, which were not mirror-coated in the hitherto described embodiment according to FIG. 7, are likewise mirror-coated partly transmissively. In this case the two microstructure objects M1 and M2 form the same microstructure object.

With such a configuration, the partly transparent concave mirrors 8 serve to present the microstructure object M1 (=M2) in magnified form to a viewer at a viewing direction onto the upper side (direction of arrow P1). At a viewing direction according to arrow P2 the microlenses 9, 9′ serve to represent the microstructure object M1 (=M2) in magnified form to a viewer.

The grids of the microstructures 5, 6 of the micro-concave mirrors 8 and of the microlenses 9, 9′ are generally different and can be calculated for example in the way stated in WO 2007/076952 A2. In particular, it can be thereby attained that the microstructure object M1 (=M2) seems to lie behind the carrier when viewed from the upper side 4, while it seems to lie in front of the carrier when viewed from the lower side 7. Alternatively, this effect can be reversed, so that the microstructure object M1 (=M2) seems to lie in front of the carrier 3 when viewed from the upper side 4, and behind the carrier 3 when viewed from the lower side 7. This impressively strengthens the impression of the three-dimensionality of the motif (microstructure object).

In a modification, the microstructure object M1 (=M2) can be arranged between two (exposed or embedded) arrays of partly transmissive micro-concave mirrors. The distance of the micro-concave mirror arrays from the microstructure object is chosen suitably, and the grid of the microstructure elements and the grids of the two micro-concave mirror arrays will normally differ from each other and can be calculated e.g. according to WO 2007/076952 A2 such that the desired magnifying imaging is attained with each of the two micro-concave mirror arrays.

A further interesting alternative of the above embodiment wherein the dashed portions in FIG. 7 are not mirror-coated consists in employing the microlenses 9′ above the micro-concave mirrors 8 as imaging elements for the micro-concave mirrors 8. For this purpose, the radius of curvature of the microlenses 9′ can be adapted to the distance from the micro-concave mirrors 8 that is reduced in comparison with the distance between the microlenses 9 and microstructures 6 in the neighboring area, in order to guarantee a sufficiently sharp imaging. Then the viewer sees the desired image as a magnified and optionally imaged representation of the microstructures 6 in the right-hand area of the security element shown in FIG. 7 from direction P2. In the left-hand area, however, he sees a magnified representation of the micro-concave mirrors 8 upon a suitable choice of the grids of microlenses 9′ and micro-concave mirrors 8, as shown schematically in FIG. 8.

The centers of the micro-concave mirrors are additionally drawn in respectively as black dots in order to more clearly illustrate the parallelogrammatic grid in which the micro-concave mirrors 8 are arranged.

In the representation of such a micro-concave mirror array there generally occur no individual peculiarities for a certain bank note due to the parallelogrammatic arrangement and the circular contours of the micro-concave mirrors 8. Individual peculiarities can be produced e.g. by the contour of the micro-concave mirrors 8 having special forms, without noticeably impairing the imaging properties of the micro-concave mirror arrangement with respect to the microstructures 5. In FIG. 9 there is shown, in the same representation as in FIG. 8, a micro-concave mirror array with micro-concave mirrors 8 of different size. In FIG. 10 there can be seen a micro-concave mirror array which consists of identical micro-concave mirrors 8 with a non-circular contour. The grids of the two examples of FIGS. 9 and 10 match the grid of the standard configuration shown in FIG. 8.

A further advantage of this method—besides the individualizable information contained in the outline form of the micro-concave mirrors 8—consists in the shown micro-concave mirror arrays completely filling the surface of the corresponding area of the security element. Therefore, the desired image to be recognized from the viewing direction P1, which arises from an interaction of the micro-concave mirrors 9 and microstructures 5, appears especially intense. It is also possible, however, to leave planar surface areas between the curved surface areas forming the micro-concave mirrors 8, although this reduces the light yield.

Regarding the two embodiment examples of FIGS. 9 and 10, it is to be noted that the contour lines do not lie on a uniform height level, as is the case with the circularly bounded micro-concave mirrors of the standard configuration (FIG. 8). Generally there results a complicated “mountain landscape”. In the embodiment example according to FIG. 9 with micro-concave mirrors 8 of unequal size, different configuration possibilities moreover present themselves. If the apexes of the micro-concave mirrors 8 lie at the same height and all micro-concave mirrors 8 have the same, for example spherical, curvature, vertical jumps can occur at the transition points between neighboring micro-concave mirrors 8 of different size. To avoid such jumps, the apexes of the smaller micro-concave mirrors 8 can alternatively be raised to a higher level located closer to the microstructures 5. This in turn requires an adaptation of the curvature of the smaller micro-concave mirrors 8, because a smaller radius of curvature than with the large micro-concave mirrors 8 is necessary due to the then reduced focal length.

Furthermore, there can be formed in this manner not only the micro-concave mirror arrays, but also microlens arrays or, quite generally, other arrangements of imaging elements with a focusing effect, such as for example Fresnel lenses. Because the outline form of the imaging elements generally has no influence on the visual appearance, the individual design of the arrangement of imaging elements can normally only be detected using an aid (for example a microscope). The structure of FIGS. 7 to 10 under discussion here constitutes an exception in this regard, because one arrangement of imaging elements (here micro-concave mirrors 8) is made visible with another arrangement of imaging elements (here microlenses 9).

In a further special embodiment with reference to FIG. 7, the areas with micro-concave mirrors 8 not are visible as surface elements with a defined contour macroscopically, i.e. with the naked eye, but have sizes below the resolving power of the eye. Moreover, the microstructures 5 and 6 can be identical. Such a security element arises for example from a micro-concave mirror arrangement bloomed in grid form (e.g. demetallized in grid form) as in FIG. 3 being bonded to a microlens grid over the full surface (the demetallizing can be effected e.g. by irradiating with a laser, by printing with a soluble washing ink before metallizing and washing after metallizing, or by printing with resist on the metallized layer and subsequent etching).

When viewing such a security element from the direction P1 one sees in incident light the structures 5 moire or modulo magnified by means of the micro-concave mirrors. In transmission against a light source, the surface of the security element appears semi-transparent in accordance with the employed gridding. When grids varying in certain areas are employed, there can be produced images that are perceptible in transmission due to brightness differences and cannot be seen in plan view. From the direction P2 one sees in transmission against a light source the microstructures 5 moire or modulo magnified with the help of the microlenses, while in plan view predominantly the magnified micro-concave mirror array can appear.

A possible extension of the security element is achievable by incorporating an additional element, for example a printed image, between the micro-concave mirrors 8 and the microlenses 9. Said element is advantageously designed so as not, or not substantially, impair the functionality of the microlenses.

In FIG. 11 there is shown a modification of the embodiments of FIGS. 7 to 10, in which modification only one PET foil 10 is employed. After application of the mirror coating 13 a second embossing lacquer layer 24 of suitable thickness is applied (for example printed) and subsequently embossed and UV-cured.

The embodiment shown in FIG. 11 can be modified such that the PET foil 10 is arranged, not between the micro-concave mirrors 8 and the microstructures 5, 6, but between the micro-concave mirrors 8 and the microlenses 9.

Further, it is possible to realize the structure shown in FIGS. 7 to 11 respectively by the three layers of microstructures 5, 6, micro-concave mirrors 8 and microlenses 9 arising from successively embossing one on the other.

In FIG. 12 there is shown an embodiment of the security element 1 wherein there are formed on both sides of the carrier 3 micro-concave mirrors 8, 8′ which are embossed in UV lacquer layers 12 and 25 and have mirror coatings 13, 13′. As indicated in FIG. 12, the upper and lower sides 4, 7 are provided complementarily with micro-concave mirrors 8, 8′. The areas 26, 27 of the upper and lower sides 4, 7 where no micro-concave mirrors 8, 8′ are formed are smooth or non-curved here in order not to influence the imaging by the micro-concave mirrors 8, 8′.

In a modification not shown, the areas 26, 27 can also be so structured that there is present a refractive effect which together with the micro-concave mirrors 8, 8′ produces the desired imaging of the microstructures 5, 6.

In a further variant not shown, the microstructures 5 and 6 are not located on a common plane between the planes equipped with micro-imaging elements, but are structured into the respective opposing plane provided with micro-imaging elements. In this manner the microstructures 5 can be embossed simultaneously with the micro-imaging elements 8′, and the microstructures 6 simultaneously with the micro-imaging elements 8. Besides this advantage, the total thickness of the security element 1 can be reduced further. Moreover, with this structure the microstructures 5 can be equipped with a different color from the microstructures 6.

It is further possible, as shown in the modification in FIG. 13, that the upper and lower sides 4, 7 are provided completely with micro-concave mirrors 8, 8′. In this case the micro-concave mirrors 8, 8′ are preferably coated semi-transparently, so that the ray trajectories indicated in FIG. 13 are possible. Because the microstructures form both the first and the second microstructure objects M1, M2, they are designated here with the reference sign 5′.

The micro-concave mirrors 8, 8′ in the embodiment examples shown in FIGS. 12 and 13 are so configured that the focal points coincide with the plane in which the microstructures 5, 6 are formed.

In FIG. 14 there is shown a further embodiment of the security element 1 wherein only micro-concave mirror 8, 8′ are used. In this embodiment, however, the micro-concave mirrors 8, 8′ are arranged inside and the associated microstructures 5, 6 outside, so that the micro-concave mirrors 8, 8′ do not influence each other.

The security element 1 according to FIG. 14 can be produced e.g. as follows. A structure according to FIG. 3 is employed twice, whereby respectively the total lower side of each structure is mirror-coated. The two structures are then bonded together with laminating adhesive 28, as shown in FIG. 14.

The security element of the invention can also be configured as a security thread 29, as indicated in FIG. 1. The security thread 29 is so integrated into the bank note 2 that it can be viewed at least in certain portions both from the front side of the bank note 2 and from the back side of the bank note 2.

In the hitherto described embodiment examples, the micro-concave mirrors 8 and the microlenses 9 are so arranged that they lie respectively in one area of two mutually adjacent areas. Other types of arrangements are also possible. Thus, there can be provided several areas with micro-concave mirrors 8 and several areas with microlenses 9 which are arranged for example alternately side by side. The areas with the micro-concave mirrors 8 and the microlenses 9 need not adjoin each other directly, regarded in a plan view of their flat arrangement, but can also be spaced apart from each other.

In the described embodiment examples, micro-concave mirrors 8, 8′ and microlenses 9 were respectively described. It is evident that the micro-concave mirrors 8, 8′ are stated to represent reflectively acting micro-imaging elements, and the microlenses 9 to represent refractively acting imaging elements. Furthermore, it is possible to use diffractive elements as reflectively and/or refractively acting micro-imaging elements, provided that they realize the desired imaging properties (in the same or a similar fashion as the micro-concave mirrors 8, 8′ or microlenses 9).

The micro-imaging elements can be formed by non-cylindrical microlenses or micro-concave mirrors, in particular by microlenses or micro-concave mirrors with a circular or polygonally bounded base surface, or also by elongate cylindrical lenses or cylindrical micro-concave mirrors whose extension in the longitudinal direction amounts to more than 250 μm, preferably more than 300 μm, particularly preferably more than 500 μm and in particular more than 1 mm. Further, it is possible to use as micro-imaging elements pinhole diaphragms, slit diaphragms, mirror-equipped pinhole diaphragms or slit diaphragms, aspherical lenses, Fresnel lenses, GRIN (gradient refraction index) lenses, zone plates, holographic lenses, concave mirrors, Fresnel mirrors, zone mirrors or other elements with a focusing or also blocking effect.

The mirror coating 13 of the micro-concave mirrors 8, 8′ can be realized e.g. by means of an applied metal layer (for example vapor-deposited). Typically there is applied an aluminum layer with a thickness of e.g. 50 nm. It is of course also possible to employ other metals, such as e.g. silver, copper, chromium, iron, etc., or alloys thereof. There can also be applied alternatively to metals high-refractive coatings, for example MgF₂, ZnS or TiO₂. If a suitable thickness is chosen, the reflective effect can be additionally increased by interference effects. For ZnS the corresponding layer thickness lies for example at about 60 nm. Thin-film systems of for example alternately high- and low-refractive layers can also be so applied that the layer sequence acts as a reflector. Such layer systems can also be made to measure for a certain wavelength.

The mirror coating can be full-surface on the individual micro-concave mirrors 8, 8′ . It is also possible, however, to carry out a coating only in certain areas or in grid form, so that the micro-concave mirrors 8, 8′ are semi-transparent. Also, the thickness of the coating can be chosen such that a semi-transparent mirror coating is present instead of a complete mirror coating.

A semi-transparent mirror coating is understood here to be in particular a mirror coating wherein the transmission averaged over at least one micro-concave mirror lies in the range of 10% to 90%.

The mirror coating can further be realized as a color-shifting coating which has e.g. a layer system of absorber, dielectric and reflector. The color-shifting side of said layer system can face, or face away from, the microstructures 5, 6. In the former case the color generated by the layer system can be adapted to the color of the microstructures 5.

Further, it is possible to cause a color-shifting effect on both sides with the layer system when e.g. a layer sequence of absorber, dielectric, reflector, dielectric and absorber is applied. The described color-shifting layer systems can also be applied over the full surface or only in certain areas.

In the described embodiments it is preferable to cover the mirror coating 13, if it is exposed, with a protective lacquer or a foil in order to protect it from harmful environmental influences. The same holds for the microlenses, whereby it must then be ensured that a refractive index difference of the coating relative to the lens material is present that is so chosen, together with the curvature of the lenses, that the desired focal length is obtained. The microstructures, if they are exposed, can also be provided with a protective layer (for example a protective lacquer or a foil). This is primarily also recommendable in order to protect the security element from unauthorized reproduction.

The security element 1 can also have further security features, such as e.g. holograms, cleartext or other known security features which are described e.g. on page 18 of the description of WO 2009/000528 A1.

1-16. (canceled)

17. A security element for security papers, value documents or the like, comprising:
a carrier having an upper side and a lower side and comprising several reflective first micro-imaging elements arranged flatly in a first pattern, and second micro-imaging elements arranged flatly in a second pattern;
a first microstructure object including a plurality of first microstructures arranged in a first microstructure pattern adapted to the first pattern such that the first microstructure object is imaged in magnified form in front of the upper side by means of the first micro-imaging elements; and
a second microstructure object including a plurality of second microstructures arranged in a second microstructure pattern adapted to the second pattern such that the second microstructure object is imaged in magnified form before the lower side by means of the second micro-imaging elements.

18. The security element according to claim 17, wherein both the first and the second microstructure objects are connected to the carrier.

19. The security element according to claim 17, wherein the first and second micro-imaging elements lie on the same side relative to the microstructure objects.

20. The security element according to claim 17, wherein the first and second micro-imaging elements lie on different sides relative to the microstructures.

21. The security element according to claim 17, wherein the first and second micro-imaging elements lie in the same plane.

23. The security element according to claim 17, wherein the first and second microstructures lie in the same plane.

24. The security element according to claim 17, wherein the first micro-imaging elements are configured as micro-concave mirrors.

25. The security element according to claim 17, wherein the second micro-imaging elements are configured as microlenses.

26. The security element according to claim 17, wherein at least one of the first micro-imaging elements also acts as a second micro-imaging element.

27. The security element according to claim 17, wherein at least one of the first and second micro-imaging elements is embedded in the carrier.

28. The security element according to claim 17, wherein at least one of the first and second micro-imaging elements is focusing imaging elements.

29. The security element according to claim 17, wherein the first and second microstructure objects are the same object.

30. The security element of claim 17, wherein the security element is incorporated into a value document.

31. A security system for security papers, value documents or the like, comprising:
a first carrier having an upper side and a lower side and comprising several reflective first micro-imaging elements arranged flatly in a first pattern, said elements having a first object plane area associated therewith, and second micro-imaging elements arranged flatly in a second pattern, said elements having a second object plane area associated therewith;
a first microstructure object comprising a plurality of first microstructures arranged in a first microstructure pattern;
a second microstructure object comprising a plurality of second microstructures arranged in a second microstructure pattern; and
a second carrier,
wherein one of the two microstructure objects is connected to the second carrier, and wherein the other of the two microstructure objects is connected to either of the first or second carrier,
wherein the first microstructure pattern is adapted to the first pattern such that the first microstructure object, when it lies in the first object plane area, is imaged in magnified form in front of the upper side of the first carrier by means of the first micro-imaging elements, and wherein
the second microstructure pattern is adapted to the second pattern such that the second microstructure object, when it lies in the second object plane area, is imaged in magnified form in front of the lower side of the first carrier by means of the second micro-imaging elements.

32. The security system of claim 31, wherein the security system is incorporated into a value document.

33. A production method of a security element for security papers, value documents or the like, the method comprising:
producing a carrier having an upper side and a lower side and comprising several reflective first micro-imaging elements arranged flatly in a first pattern, and second micro-imaging elements arranged flatly in a second pattern;
producing a first microstructure object having several first microstructures such that they are arranged in a first microstructure pattern adapted to the first pattern such that the first microstructure object is imaged in magnified form in front of the upper side by means of the first micro-imaging elements; and
producing a second microstructure object having several second microstructures such that they are arranged in a second microstructure pattern adapted to the second pattern such that the second microstructure object is imaged in magnified form in front of the lower side by means of the second micro-imaging elements.

34. A production method of a security system for security papers, value documents or the like, the method comprising:
producing a first carrier having an upper side and a lower side and comprising several reflective first micro-imaging elements arranged flatly in a first pattern, said elements having a first object plane area associated therewith, and second micro-imaging elements arranged flatly in a second pattern, said elements having a second object plane area associated therewith;
producing a first microstructure object comprising a plurality of first microstructures arranged in a first microstructure pattern; and
producing a second microstructure object comprising a plurality of second microstructures arranged in a second microstructure pattern,
whereby one of the two microstructure objects is connected to a second carrier, and the other of the two microstructure objects either to the first or second carrier, the first microstructure pattern adapted to the first pattern such that the first microstructure object, when it lies in the first object plane area, is imaged in magnified form in front of the upper side of the first carrier by means of the first micro-imaging elements, and the second microstructure pattern adapted to the second pattern such that the second microstructure object, when it lies in the second object plane area, is imaged in magnified form in front of the lower side of the first carrier by means of the second micro-imaging elements.
